(19) United States
(12) Patent Application Publication
(10) Pub. No.: US 2024/0331412 A1
(43) Pub. Date: Oct. 3, 2024

(54) AUTOMATICALLY DETERMINING THE PART(S) OF AN OBJECT DEPICTED IN ONE OR MORE IMAGES

(71) Applicant: Bayer Aktiengesellschaft, Leverkusen (DE)

(72) Inventors: Gerard SANROMA GÜELL, Leverkusen (DE); Markus BLANK, Glienicke (DE); Mark Alexander KLEMENS, Berlin (DE)

(73) Assignee: Bayer Aktiengesellschaft, Leverkusen (DE)

(21) Appl. No.: 18/580,508

(22) PCT Filed: Jul. 18, 2022
(86) PCT No.: PCT/EP2022/069976

§ 371 Date: Jan. 18, 2024

(30) Foreign Application Priority Data
Jul. 20, 2021 (EP) 21186546.4

(51) Int. Cl. G06V 20/64; G06V 10/774; G06V 10/776; G06V 40/10

(52) U.S. Cl. CPC G06V 20/64; G06V 10/774; G06V 10/776; G06V 40/10; G06V 2201/03

(57) ABSTRACT

The present invention relates to the technical field of automatically determining the content of images. In particular, the present invention relates to a process for assigning images to predefined categories depending on their content. Subject matter of the present invention is a computer-implemented method of automatically determining to which part of an object the content depicted in one or more images belongs to, a computer system configured to execute the computer-implemented method, and a non-transitory computer-readable storage medium comprising processor-executable instructions with which to perform the computer-implemented method.

### CROSS-REFERENCE TO RELATED APPLICATIONS

This application is a national stage application under 35 U.S.C. § 371 of International Application No. PCT/EP2022/069976, filed internationally on Jul. 18, 2022, which claims the benefit of priority to European Application No. 21186546.4, filed on Jul. 20, 2021.

### FIELD

The present disclosure relates to the technical field of automatically determining the content of images. In particular, the present disclosure relates to a process for assigning images to predefined categories depending on their content. The subject matter of the present disclosure includes a computer-implemented method of automatically determining to which part of an object the content depicted in one or more images belongs to, a computer system configured to execute the computer-implemented method, and a non-transitory computer-readable storage medium comprising processor-executable instructions with which to perform the computer-implemented method.

### BACKGROUND

Machine learning has seen some dramatic developments recently, leading to a lot of interest from industry and academia. These are driven by breakthroughs in artificial neural networks, often termed deep learning, a set of techniques and algorithms that enable computers to discover complicated patterns in large data sets.

Accordingly, deep learning algorithms get a lot of attention these days to solve various problems in particular in medical imaging fields. One example is to detect a disease or abnormalities from medical images and classify them into several disease types or severities.

For the training of machine learning models, training data are required. Although more and more data are being generated, many of these data are unsuitable for training purposes. It is becoming increasingly difficult to find the relevant data for a particular machine learning problem. An important criterion for the relevance of the data to a particular problem is its content. For example, images from the human lungs may be required for training of a machine learning model to detect lung abnormalities. However, information about the anatomical content of a medical image is usually unavailable, inaccurate, or incorrect. Healthcare providers generate and capture enormous amounts of data containing extremely valuable signals and information for a potentially large range of applications; however, accurate meta-information about their anatomic content is required in order to make them accessible for other applications beyond the ones for which they were originally created.

Thus, there is need for methods that enrich the meta-information of images with accurate information about their content in order to facilitate re-use of data for various purposes.

### SUMMARY

The present disclosure addresses this need.

Therefore, the present disclosure provides, in a first aspect, a computer-implemented method comprising the following steps:
receiving at least one image, the image representing a slice, the slice being oriented perpendicular to an axis of a volume of an object,
inputting the at least one image into a first model, receiving, from the first model, for each image inputted into the first model, a slice score, the slice score being representative of the position of the slice within the object along the axis,
inputting the slice score into a second model,
receiving from the second model an object part information, the object part information indicating to which part/parts of the object the slice belongs to,
outputting and or storing the object part information and/or information related thereto.

In a second aspect, the present disclosure provides a computer system comprising a processor and a memory storing an application program configured to perform, when executed by the processor, an operation, the operation comprising:
receiving at least one image, the image representing a slice, the slice being oriented perpendicular to an axis of a volume of an object,
inputting the at least one image into a first model,
receiving, from the first model, for each image inputted into the first model, a slice score, the slice score being representative of the position of the slice within the object along the axis,
inputting the slice score into a second model,
receiving from the second model an object part information, the object part information indicating to which part/parts of the object the slice belongs to,
outputting and or storing the object part information and/or information related thereto.

In a third aspect, the present disclosure provides a non-transitory computer-readable medium having stored thereon software instructions that, when executed by a processor of a computer system, cause the computer system to execute the following steps:
receiving at least one image, the image representing a slice, the slice being oriented perpendicular to an axis of a volume of an object,
inputting the at least one image into a first model,
receiving, from the first model, for each image inputted into the first model, a slice score, the slice score being representative of the position of the slice within the object along the axis,
inputting the slice score into a second model,
receiving from the second model an object part information, the object part information indicating to which part/parts of the object the slice belongs to,
outputting and or storing the object part information and/or information related thereto.

### BRIEF DESCRIPTION OF THE FIGURES

Additional advantages and details of non-limiting embodiments are explained in greater detail below with reference to the exemplary embodiments that are illustrated in the accompanying figures, in which:

FIG. 1 (a) shows a first embodiment of a model.

FIG. 1 (b) shows a second embodiment of a model.

FIG. 1 (c) shows a third embodiment of a model.

FIG. 2 shows a set of four images I1, I2, I3, and I4, each showing a slice within a volume of an object, according to some embodiments.

FIG. 3 shows an example of slice scores for four slices, according to some embodiments.

FIG. 4 shows the body of a person that has been divided into a number of sections, each section representing a body part, according to some embodiments.

FIG. 5 shows the body of the person depicted in FIG. 4 divided into the body parts BP1, BP2, BP3, BP4, BP5, and BP6, according to some embodiments.

FIG. 6 (a) shows the person depicted in FIGS. 4-5 with a volume identified by the reference symbol V.

FIG. 6 (b) shows the person depicted in FIGS. 4-5 with a volume identified by the reference symbol V.

FIG. 7 shows a schematic of a first model M1 that is configured to generate, for each image of the set of images, a slice score and a second model M2 that is configured to determine, on the basis of one or more slice scores, a body part information R, according to some embodiments.

FIG. 8 shows a schematic of a first model M1 that is configured to generate, for each 2D image inputted into the first model, a slice score, the slice score representing the position of the slice within the object along the defined axis and a second model M2 that is configured to determine, on the basis of one or more slice scores, an object part information R2, according to some embodiments.

FIG. 9 shows a computer system, according to some embodiments.

### DETAILED DESCRIPTION

The disclosure will be more particularly elucidated below without distinguishing between the different aspects of the disclosure (method, computer system, computer-readable storage medium). On the contrary, the following elucidations are intended to apply analogously to all the aspects of the disclosure, irrespective of in which context (method, computer system, computer-readable storage medium) they occur.

If steps are stated in an order in the present description or in the claims, this does not necessarily mean that the disclosure is restricted to the stated order. On the contrary, it is conceivable that the steps can also be executed in a different order or else in parallel to one another, unless one step builds upon another step, this absolutely requiring that the building step be executed subsequently (this being, however, clear in the individual case). The stated orders are thus preferred embodiments of the disclosure.

The present disclosure provides means for automatically determining the part or the parts of an object depicted in one or more images.

The term “object” as used herein means a physical object, preferably an organism or part(s) thereof, more preferably a living organism or part(s) thereof (such as an organ), most preferably a human being or an animal or a plant or part(s) thereof.

In a preferred embodiment, an “object” according to the present disclosure is a human being, e.g., a patient or a part thereof such as an organ (like the heart, the brain, the lungs, the liver, the kidney, an eye, the pancreas, a leg, an arm, the hip, the teeth, a hand, a foot, a breast, or others or combinations thereof.

For the sake of simplicity, the disclosure is described at some point in the present description using the example of a human being as an object. However, this simplification is not intended to mean that the present disclosure is limited to a human being as an object. Rather, the disclosure can be applied to all physical objects.

The term “image” as used herein means a data structure that represents a spatial distribution of a physical signal. The spatial distribution may be of any dimension, for example 2D, 3D, 4D or any higher dimension. The spatial distribution may be of any shape, for example forming a grid and thereby defining pixels, the grid being possibly irregular or regular. The physical signal may be any signal, for example proton density, tissue echogenicity, measurements related to the blood flow, information of rotating hydrogen nuclei in a magnetic field, color, level of gray, depth, surface or volume occupancy, such that the image may be a 2D or 3D RGB/grayscale/depth image, or a 3D surface/volume occupancy model.

The image is usually available as a digital file. Examples of digital image file formats can be found in doi: 10.2349/biij.2.1.e6.

In a preferred embodiment, an “image” according to the present disclosure is a medical image.

A “medical image” is a visual representation of a subject's body or a part thereof.

Techniques for generating (medical) images include X-ray radiography, computerized tomography, fluoroscopy, magnetic resonance imaging, ultrasonography, endoscopy, elastography, tactile imaging, thermography, microscopy, positron emission tomography and others.

Examples of (medical) images include computer tomography scans, X-ray images, magnetic resonance imaging scans, fluorescein angiography images, optical coherence tomography scans, histopathological images, ultrasound images and others.

A widely used format for digital medical images is the DICOM format (DICOM: Digital Imaging and Communications in Medicine).

The present disclosure makes use of at least two models, a first model and a second model. The first model and/or the second model can be machine learning model(s). In a preferred embodiment of the present disclosure, at least the first model is a machine learning model.

Such a machine learning model, as used herein, may be understood as a computer implemented data processing architecture. The machine learning model can receive input data and provide output data based on that input data and the machine learning model, in particular the parameters of the machine learning model. The machine learning model can learn a relation between input and output data through training. In training, parameters of the machine learning model may be adjusted in order to provide a desired output for a given input.

The process of training a machine learning model involves providing a machine learning algorithm (that is the learning algorithm) with training data to learn from. The term machine learning model refers to the model artifact that is created by the training process. The training data must contain the correct answer, which is referred to as the target. The learning algorithm finds patterns in the training data that map input data to the target, and it outputs a machine learning model that captures these patterns.

In the training process, training data are inputted into the machine learning model and the machine learning model generates an output. The output is compared with the (known) target. Parameters of the machine learning model are modified in order to reduce the deviations between the output and the (known) target to a (defined) minimum.

In general, a loss function can be used for training to evaluate the machine learning model. For example, a loss function can include a metric of comparison of the output and the target. The loss function may be chosen in such a way that it rewards a wanted relation between output and target and/or penalizes an unwanted relation between an output and a target. Such a relation can be, e.g., a similarity, or a dissimilarity, or another relation.

A loss function can be used to calculate a loss value for a given pair of output and target. The aim of the training process can be to modify (adjust) parameters of the machine learning model in order to reduce the loss value to a (defined) minimum.

A loss function may for example quantify the deviation between the output of the machine learning model for a given input and the target. If, for example, the output and the target are numbers, the loss function could be the difference between these numbers, or alternatively the absolute value of the difference. In this case, a high absolute value of the loss function can mean that a parameter of the model needs to undergo a strong change.

In the case of a scalar output, a loss function may be a difference metric such as an absolute value of a difference, a squared difference.

In the case of vector-valued outputs, for example, difference metrics between vectors such as the root mean square error, a cosine distance, a norm of the difference vector such as a Euclidean distance, a Chebyshev distance, an Lp-norm of a difference vector, a weighted norm or any other type of difference metric of two vectors can be chosen. These two vectors may for example be the desired output (target) and the actual output.

In the case of higher dimensional outputs, such as two-dimensional, three-dimensional or higher-dimensional outputs, for example an element-wise difference metric may for example be used. Alternatively or additionally, the output data may be transformed, for example to a one-dimensional vector, before computing a loss function.

The trained machine learning model can be used to get predictions on new data for which the target is not (yet) known. The training of the machine learning models of the present disclosure is described in more detail below.

The models of the present disclosure are used in a way that data generated by the first model is inputted into the second model. The first model and the second model can be separated from each other or they can be linked to each other so that output data generated by the first model is directly fed as input into the second model. If the models are separated from each other, output data from the first model can be inputted into the second model manually or automatically (e.g., by means of a computer system being configured by a respective software program to take output data from the first model and feed the output data into the second model).

The reason why in this disclosure two different models are described is that these models are usually configured and/or trained separately and independently of each other. However, this should not be taken as a restriction of the disclosure to a system comprising two (separate) models. The present disclosure is to be understood that it encompasses directly linked models as well as a (combined) model in which the functions of the first model and the second model are integrated.

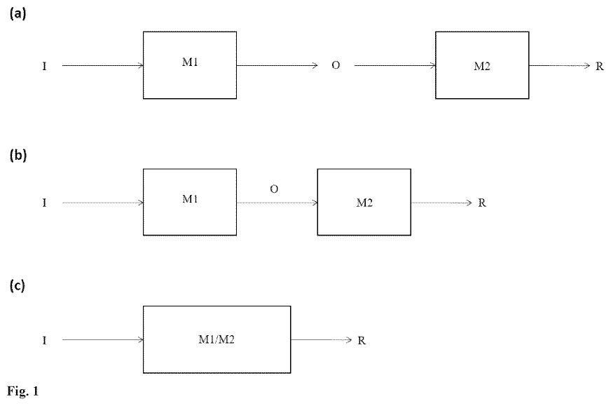

FIGS. 1 (a), 1 (b), and 1 (c) show schematically three different embodiments of the models of the present disclosure. Both, FIGS. 1 (a), and 1 (b) show a first model M1, and a second model M2. The first model M1 is configured to receive input data I. In the embodiment shown in FIG. 1 (a), the first model M1 is configured to generate output data O which are outputted. The outputted output data O can then be inputted into the second model M2 which is configured to generate, on the basis of the output data O, a result R which is outputted. In the embodiment shown in FIG. 1 (b), the output data O generated by the first model is directly fed into the second model (without being outputted). In the embodiment shown in FIG. 1 (c), the first model M1 and the second model M2 are merged into one combined model which is configured to receive input data I and output the result R.

The first model according to the present disclosure is configured to receive at least one image.

In a preferred embodiment, a set of images comprising a plurality of images is received by the first model.

The term “plurality” as it is used herein means a natural number greater than 1, e.g., 2, 3, 4, 5, 6, 7, 8, 9, 10 or any other number greater than 10.

The at least one image represents a slice within an object. The slice is oriented perpendicular to an axis of a volume of the object.

A slice that is depicted in an image is usually planar (not curved).

If a plurality of images is inputted into the first model, each image represents a slice within the object. Each slice is oriented perpendicular to an axis of a volume of the object. In a preferred embodiment, the distance between two directly adjacent slices is the same for all directly adjacent slices.

The volume of the object can encompass all or part(s) of the object.

The axis can be an axis of symmetry of the volume of the object. In a preferred embodiment, the axis is the vertical axis, the longitudinal axis or the transverse axis of the volume of the object placed in a Cartesian coordinate system. In a preferred embodiment, the zero point of the Cartesian coordinate system corresponds to the center of gravity of the volume of the object.

In case of the object being a human being or an animal, the axis of the volume preferably corresponds to one of the main body axes: the vertical axis, the sagittal axis, or the coronal axis (as defined below).

Preferably, the axis corresponds to the vertical axis of the body.

In a preferred embodiment of the present disclosure, each slice which is depicted in an image of a set of images is oriented parallelly to one of the main planes of the volume of the object. In case of the object being a human being, these main planes are the coronal plane, the sagittal plane, and the axial plane (as defined below). Preferably, the slices are oriented parallelly to the axial plane of the human body.

The coronal (frontal) plane divides the body into front section and back section (see, e.g., DOI: 10.1007/978-94-007-4488-2_3, FIG. 3.2).

The sagittal (longitudinal) plane divides the body into left section and right section (see, e.g., DOI: 10.1007/978-94-007-4488-2_3, FIG. 3.2).

The axial (horizontal or transversal) plane divides the body into upper and lower segments (see e.g. DOI: 10.1007/978-94-007-4488-2_3, FIG. 3.2).

The sagittal axis or anterior-posterior axis is the axis perpendicular to the coronal plane, i.e., the one formed by the intersection of the sagittal and the transversal planes (see, e.g., DOI: 10.1186/s40648-019-0136-z, FIG. 3)

The coronal axis or medial-lateral axis is the axis perpendicular to the sagittal plane, i.e., the one formed by the intersection of the coronal and the transversal planes (see, e.g., DOI: 10.1186/s40648-019-0136-z, FIG. 3).

The vertical axis or proximal-distal axis is the axis perpendicular to the transversal plane, i.e., the one formed by the intersection of the coronal and the sagittal planes (see, e.g., DOI: 10.1186/s40648-019-0136-z, FIG. 3).

In a preferred embodiment of the present disclosure, each slice which is depicted in an image of a set of images is oriented parallelly to the axial plane and perpendicular to the vertical axis.

If the set of images comprises 2D images that represent a stack of slices with the slices not oriented perpendicular to a defined axis, they can be converted into a stack of slices with the slices oriented perpendicular to the defined axis.

It is for example possible to reconstruct a 3D representation (a 3D image) from the stack of slices and generate, from the 3D representation, a stack of slices that are oriented perpendicular to the defined axis.

Methods for the reconstruction of 3D representations from 2D images are disclosed in the prior art (see, e.g., Aharchi M., Ait Kbir M.: A Review on 3D Reconstruction Techniques from 2D Images, DOI: 10.1007/978-3-030-37629-1_37; Ehlke, M.: 3D-Rekonstruktion anatomischer Strukturen aus 2D-Röntgenaufnahmen, DOI: 10.14279/depositonce-11553).

3D representation can be converted to a 2D series e.g. by using nifti2dicom (see, e.g., https://neuro.debian.net/pkgs/nifti2dicom.html).

Therefore, in an embodiment of the present disclosure, the method according to the present disclosure further comprises the following steps:
receiving a 3D representation of a volume of an object,
generating a set of 2D images from the 3D representation, each 2D image representing a slice, each slice being oriented perpendicular to a defined axis of the volume of the object.

In another embodiment of the present disclosure, the method according to the present disclosure further comprises the following steps:
receiving a set of 2D images, the set of 2D images representing a stack of slices of a volume of an object, wherein the slices are not oriented perpendicular to a defined axis of the volume of the object,
generating a 3D representation of the volume from the set of 2D images,
generating a new set of 2D images from the 3D representation, each 2D image of the new set of 2d images representing a slice, each slice being oriented perpendicular to the defined axis of the volume of the object.

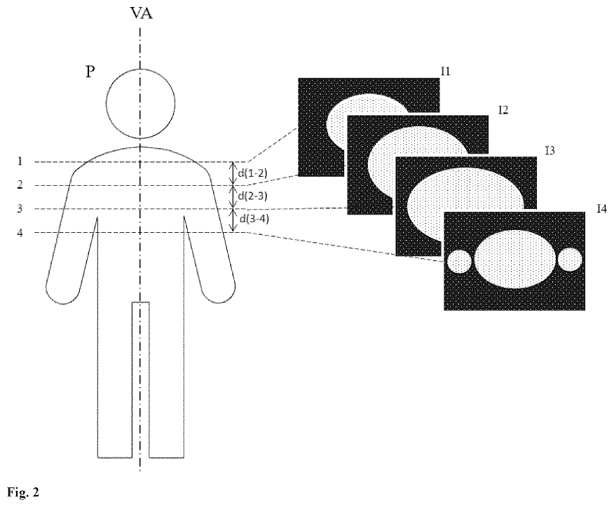

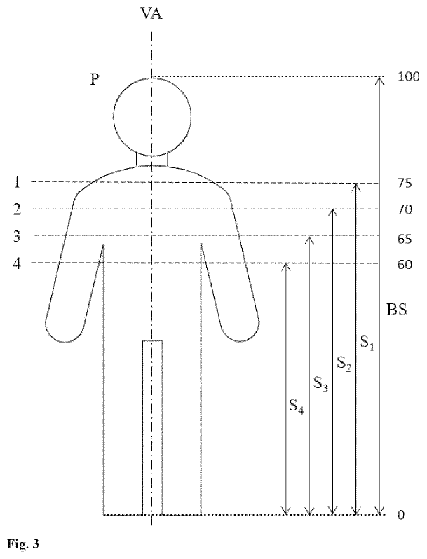

FIG. 2 shows schematically by way of example a set of four images I1, I2, I3, and I4, each of the images showing a slice within a volume of an object. The object is a person P. Image I1 shows slice 1, image I2 shows slice 2, image I3 shows slice 3, and image 4 shows slice 4. The slices 1, 2, 3, and 4 are oriented parallelly to each other. The slices 1, 2, 3, and 4 are oriented along the axis VA and perpendicular to the axis VA. The axis VA corresponds to the vertical axis of the person P. The slices 1, 2, 3, and 4 are oriented parallelly to the axial plane of the person P. Each pair of directly adjacent slices has the same distance between the slices: slice 1 and 2 are directly adjacent to each other and the distance between them is d(1-2); slice 2 and 3 are directly adjacent to each other and the distance between them is d(2-3); slice 3 and 4 are directly adjacent to each other and the distance between them is d(3-4); the distances d(1-2), d(2-3) and d(3-4) are the same.

In the context of the present disclosure, a first model is used. The first model is configured to determine, for each image inputted into the model, a slice score. The slice score represents the position of the slice within the volume of the object.

The slice score can, e.g., be the axial slice score described in K. Yan et al.: Unsupervised body part regression using a convolutional neural network with self-organization, arXiv: 1707.03891v1 [cs.CV], hereinafter referred to as Yan_2017. Yan_2017 is incorporated into this description in its entirety by reference.

In a preferred embodiment of the present disclosure, the slice score is characterized by one or more of the following properties:
The slice score is a continuous value.
The slice score represents the position of the slice along the vertical axis, the longitudinal axis, or the transverse axis of the volume of the object in a Cartesian coordinate system. In case of the object being a human being, the slice score preferably represents the position of the slice along the coronal, sagittal or vertical axis of the human being, most preferably along the vertical axis.
The slice score represents the normalized coordinate of the slice within the object, wherein the slice score is normalized to the size of the object extension in the direction of the axis that is perpendicular to the slice. In case of the object being a human, the slice is preferably oriented parallelly to the axial plane of the human body, and the slice score is normalized to the size of the human body in the direction of the vertical axis (=normalized to the body height of the human being).

FIG. 3 shows schematically an example of slice scores for four slices. FIG. 3 shows the same person P as depicted in FIG. 2. There are four slices (1, 2, 3, and 4) which are oriented parallelly to the axial plane along the vertical axis VA of the person P. A slice score is given for each slice: slice 1 is characterized by the slice score S₁, slice 2 is characterized by the slice score S₂, slice 3 is characterized by the slice score S₃, and slice 4 is characterized by the slice score S₄. Each slice score represents the position of the respective slice within the person's body. The person P has a body height BS. In the example shown in FIG. 3, the slice scores are normalized to the body height BS of the person P. If for example the body height BS of the person is normalized to a value of 100, and the soles of the feet are assigned to the coordinate value zero (0), then the following values result for the slice scores: S₁=75, S₂=70, S₃=65, and S₄=60.

In a preferred embodiment, the first model is or comprises an artificial neural network. An artificial neural network (ANN) is a biologically inspired computational model. An ANN usually comprises at least three layers of processing elements: a first layer with input neurons, an Nth layer with at least one output neuron, and N−2 inner layers, where N is a natural number greater than 2. In such a network, the input neurons serve to receive the input data. If the input data constitutes or comprises an image, there is usually one input neuron for each pixel/voxel of the input image; there can be additional input neurons for additional input data such as data about the object represented by the input image, the type of image, the way the image was acquired and/or the like. The output neurons serve to output one or more values, e.g., a slice score for the image inputted into the ANN.

The processing elements of the layers are interconnected in a predetermined pattern with predetermined connection weights therebetween. Each network node represents a (simple) calculation of the weighted sum of inputs from prior nodes and a non-linear output function. The combined calculation of the network nodes relates the inputs to the outputs.

In a preferred embodiment, the first model is or comprises a convolutional neural network (CNN). A CNN is a class of deep neural networks, most commonly applied to analyzing visual imagery. A CNN comprises an input layer with input neurons, an output layer with at least one output neuron, as well as multiple hidden layers between the input layer and the output layer.

The hidden layers of a CNN typically comprise convolutional layers, ReLU (Rectified Linear Units) layers, i.e., activation function, pooling layers, fully connected layers and normalization layers.

The nodes in the CNN input layer can be organized into a set of “filters” (feature detectors), and the output of each set of filters is propagated to nodes in successive layers of the network. The computations for a CNN include applying the mathematical convolution operation with each filter to produce the output of that filter. Convolution is a specialized kind of mathematical operation performed with two functions to produce a third function. In convolutional network terminology, the first function of the convolution can be referred to as the input, while the second function can be referred to as the convolution kernel. The output may be referred to as the feature map. For example, the input of a convolution layer can be a multidimensional array of data that defines the various color components of an input image. The convolution kernel can be a multidimensional array of parameters, where the parameters are adapted by the training process for the neural network.

The objective of the convolution operation is to extract features (such as, e.g., edges from an input image). Conventionally, the first convolutional layer is responsible for capturing the low-level features such as edges, color, gradient orientation, etc. With added layers, the architecture adapts to the high-level features as well, giving a network which has the wholesome understanding of images in the dataset. Similar to the convolutional layer, the pooling layer is responsible for reducing the spatial size of the feature maps. It is useful for extracting dominant features with some degree of rotational and positional invariance, thus maintaining the process of effectively training of the model. Adding a fully-connected layer is a way of learning non-linear combinations of the high-level features as represented by the output of the convolutional part.

Examples of a CNN for generating slice scores on the basis of images is given in Yan_2017.

Training of the first model can be done as follows:
The training data comprise, for each object of a multitude of objects, a set of reference images, each reference image representing a slice along an axis of a volume of the object, each slice being oriented perpendicular to the axis. In case of the object being a human, the axis is preferably the vertical axis of the human body.
The training data further comprise, for each object of a multitude of objects, a slice order, the slice order indicating the order in which the slices follow one each other along the axis of the volume of the object. Usually, each slice and/or the reference image showing the slice comprise(s) an index, the index being representative of the location of the slide within the sequence of slices along the axis. The slice order can also be derived from physical coordinates of the images. In case of DICOM images, the DICOM attribute “(0020,0032) Image Position (Patient)” provides physical coordinates of the slices depicted in the image (see, e.g.,: https://dicom.innolitics.com/ciods/ct-image/image-plane/00200032).
Preferably (but not necessarily) each pair of directly adjacent slices depicted in the reference images has the same distance between the slices.
In each iteration of training, a set of reference images is randomly selected, from each selected set a number m of equidistant slices are selected (m being an integer greater than 1), and the slices are inputted into the first model which is configured to determine a slice score for each image inputted.
A loss value is calculated for each set of inputted slices using a loss function L which comprises two loss terms, a first loss term L1 and a second loss term L2. The loss function L can be the sum of the first loss term and the second loss term (see equation (3) of Yan_2017).
The first loss term L1 is the order loss which requires slices with larger indices to have larger slice scores. In other words: the order of the indices of the slices must be consistent with the magnitude of the slice score. For example: if there are three slices following one another along the axis with the indices 1, 2, and 3, then the following must apply for the respective score values: S1<S2<S3. An example of such an order loss term (L_{order}) is given by equation (1) of Yan_2017:

$${L}_{order} = - {\sum }_{i = 1}^{g} {\sum }_{j = 1}^{m - 1} log h ( S ( i , j + 1 ) - ( S ( i , j ) )$$

in which i is an index representing a volume, g is the number of volumes selected for a training iteration, j is an index representing a slice, m is the number of slices in each volume, S(i,j) is the slice score of slice j in volume i, h is the sigmoid function.
The second loss term L₂ is the distance loss which requires that the difference of the slice scores of equidistant slices must be equal. For example: if there are three slices following one another along the axis with the indices 1, 2, and 3, and the distance between slice 1 and 2 is the same as the distance between 2 and 3, than the absolute difference of the slice scores S₂ and S₁ must equal the absolute difference of the slice scores S₃ and S₂: |S₂−S₁|=|S₃−S₂|. An example of such a distance loss term (L_{dist}) is given by equation (2) of Yan_2017:

$${L}_{dist} = {\sum }_{i = 1}^{g} {\sum }_{j = 1}^{m - 2} f ( {Δ}_{i , j + 2} - {Δ}_{i , j + 1} ) ,$$

$${Δ}_{i , j} = ( S ( i , j ) ) - ( S ( i , j - 1 ) )$$

wherein f is the smooth L1 loss (see, e.g., arXiv:1504.08083).

In a preferred embodiment, one or more further loss term(s) is/are added to the loss function L.

In a preferred embodiment, a slice-gap loss is added as an additional loss term to the loss function. The slice-gap loss requires that the difference between two slice scores is proportional to the physical distance between the two slices. If two slices in a volume i are selected, the slices having the indices j and k and the distance between the two slices being dᵢ (sliceⱼ, sliceₖ) then the ratio R_{i,j,k} of the difference of the slice scores to the distance is a value c which is constant for each pair of slices for all volumes:

$${R}_{i , j , k} ≡ \frac{{S}_{ij} - {S}_{i , k}}{{d}_{i} ( {slice}_{j} , {slice}_{k} )} = c$$

Such slice-gap loss is a consistency loss which increases the accuracy of the slice scores.

An example of a respective loss term of the slice-gap loss can be:

$${L}_{slice - gap} = {\sum }_{i = 1}^{g - 1} f ( {R}_{i , 1 , m} - {R}_{i + 1 , 1 , m} )$$

where f is the smooth L1 loss.

The physical distance can, e.g., be obtained from the physical coordinates. For example, in case of DICOM images, the DICOM attribute “(0020,0032) Image Position (Patient)” provides physical coordinates of the slices depicted in the image (see, e.g.,: https://dicom.innolitics.com/ciods/ct-image/image-plane/00200032).

In a preferred embodiment, during training, low-resolution versions of images are generated and inputted, together with the original images they were generated from, into the first model. A down-sampling loss term is added to the loss function which requires the slice score of each low-resolution image to be same as the slice score of the corresponding original image:

Sᵢ^{low}=Sᵢ^{origin}

This approach allows the determination of slice scores for a set of images which were not acquired along a certain axis. If for example the main axes of a cuboid volume from which one 3D image or a couple of 2D images is/are acquired are not oriented parallelly to the main axes of the object's body, images representing slices which are oriented parallelly to one of the main body planes of the object can still be generated (reconstructed). However, such reconstructed axial slices from non-axial volumes usually contain reconstruction artefacts. The down-sampling loss increases the robustness of the first model with respect to such reconstruction artefacts and thereby allow the acquisition of images in any direction.

An example of a respective loss term for the down-sampling-loss can be:

$${L}_{down - sampling} = {\sum }_{i = 1}^{g - 1} f ( {S}_{i}^{low} - {S}_{i}^{origin} )$$

where f is the smooth L1 loss.

A low-resolution image can be obtained from an original image, e.g., by down-sampling (see, e.g., doi: 10.3390/computers8020030).

The total loss function L can, e.g., be the weighted sum of the loss terms:

L=α·L_{order}+β·L_{dist}+γ·L_{slice-gap}+δ·L_{down-sampling}

α, β, γ and δ are weighting factors which can be used to weight the losses, e.g., to give to a certain loss more weight than to another loss. α, β, γ and δ can be any value greater than or equal to zero; usually &, β, γ and δ represent a value greater than zero and smaller or equal to one. In case of α=β=γ=δ=1, each loss is given the same weight. Note, that α, β, γ and δ can vary during the training process.

Once one or more slice scores are generated, it/they can be inputted into the second model. The second model is configured to receive one or more slice scores and determine one or more part(s) of the object the respective image(s) is/are showing. For example, in a preferred embodiment, the second model is configured to receive the slice scores of the first and last slices of the object and to determine the one or more part(s) of the object the respective image(s) is/are showing.

In an embodiment of the present disclosure, the slice score of an image is inputted into the second model. The second model can be a machine learning model that is trained in a supervised learning to learn a relationship between slices scores and the parts of an object related thereto (classification task). After training, the machine learning model outputs, for each slice score inputted into the model, information about the object part the slice belongs to. Training of the second model can, e.g., be done by supervised training. Only a few (10 to 100) annotated images are required to train the second model to learn a relationship between a slice score and the part of the object the respective slice belongs to. The second model can be or comprise an artificial neural network.

The second model can also be based on a probabilistic programming approach (see, e.g., doi: 10.7717/peerj-cs.55). The second model can, e.g., be trained to learn probability distributions for the beginning and ending of anatomic positions of each object part. Once trained, the model determines a probability for each slice score inputted into the model, the probability indicating the probability that the respective slice belongs to a defined part of the object.

The second model can also be or comprise a lookup table. In such a lookup table it can be specified for individual slice scores and/or for ranges of slice scores which parts of an object are assigned to these slice scores or these ranges. In an embodiment of the present disclosure, the slice score of an image is inputted into the second model. The second model is configured to determine, on the basis of a lookup table, the part of the object the slice is belonging to.

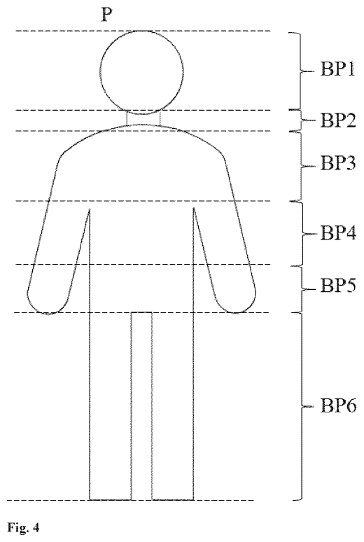

In case of the object being a human, for the determination of the respective body part(s), the human body can be divided into a number of sections. An example is shown in FIG. 4. FIG. 4 shows the body of a person P. The body is divided into a number of sections, each section representing a body part. In the example shown in FIG. 4, the body is divided into the body parts BP1, BP2, BP3, BP4, BP5, and BP6. It is possible to have a higher or a lower number of body parts. A name can be assigned to each body part; the body can, e.g., be divided into the following body parts: brain, neck, thorax, abdomen, pelvic, legs. In the example shown in FIG. 4, the body is divided into parts in a way that results in body parts being directly adjacent to each other. However, it is also possible for two or more body parts to, at least partially, overlap each other, and/or it is also possible for two or more body parts to be spaced from each other.

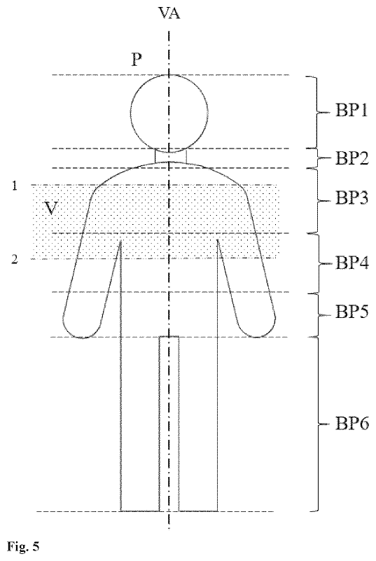

In a preferred embodiment, at least two (preferably exactly two) slice scores are inputted into the second model, the respective slices limiting the volume which is represented by the set of images inputted into the first model, along an axis. This is schematically shown in FIG. 5. FIG. 5 shows the same person P as depicted in FIG. 4. The body of the person P is divided into the body parts BP1, BP2, BP3, BP4, BP5, and BP6. A set of images can be generated, each image representing a slice in a volume V of the person's body. There are two slices, slice 1 and slice 2 which limit the volume V along the axis VA. In a preferred embodiment of the present disclosure, (only) the slice scores of these limiting slices are inputted into the second model. The second model then outputs the body part(s) which is/are covered by the volume between the two limiting slices.

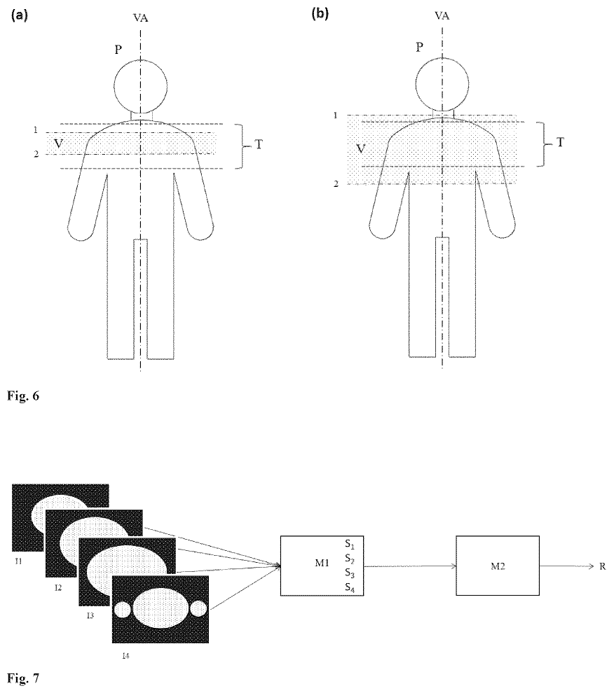

In a preferred embodiment, the percentage of coverage of the volume depicted in the set of images with one or more body parts is determined and outputted by the second model. This is schematically shown in FIG. 6 (a) and FIG. 6 (b). Both FIG. 6 (a) and FIG. 6 (b) show the same person P as depicted in FIG. 4 and FIG. 5. The volume which is depicted in the set of images is identified by the reference symbol V. The volume is limited by slice 1 and slice 2. One body part is shown FIG. 6 (a) and FIG. 6 (b): it is the thorax T. In the example shown in FIG. 6 (a) the coverage of the volume V with the body part T is 50%. In the example shown in FIG. 6 (b) the coverage of the volume V with the body part T is 100% (the volume covers 100% of the body part T).

It is possible that the volume covers more than one body part.

In a preferred embodiment, the second model is configured to compute the coverage of each body part contained in a volume by the set of images depicted the volume. The second model uses, as an input, the slice scores of the slices limiting the volume in the direction of the defined axis: the first slice s₁ representing the beginning of the volume and the last slice sₙ representing the ending of the volume in the direction of the defined axis.

The coverage is defined as the proportion of the object part that is contained in the volume. The coverage for a particular object part “part” is computed based on the intersection between the interval S=[s₁ . . . sₙ] and the canonical interval for the respective part [symbol] ^{part}=[sᵢₙᵢ^{part} . . . s_{end}^{part}], where sᵢₙᵢ^{part} and s_{end}^{part} are the canonical scores for the initial and end landmarks of the respective object part (here, in case of the object being a human, “part” can, e.g., be “neck”, “thorax”, etc.).

The coverage for the object part “part” is then computed as the ratio of the length of the intersection to the length of the object part, as follows:

Cₚₐᵣₜ(S)=len(S∩ [symbol] ^{part})/len( [symbol] ^{part})

wherein len (⋅) is the length of the interval.

The canonical scores can be obtained by means of annotations on the beginning and end slice numbers for a number of object parts for a number of objects N. That is [symbol] ᵢ^{part} and εᵢ^{part} are the initial and end slice numbers, respectively, for object part “part” in the volume of object i.

The canonical scores for the initial and end landmarks for each part is computed as the average of the scores in the annotated samples. That is:

$${\&}_{ini}^{part} = \frac{1}{N} {\sum }_{i}^{N} {S}_{i , j} ,$$

$$j = {𝒥}_{i}^{pa rt}$$

$${\&}_{end}^{part} = \frac{1}{N} {\sum }_{i}^{N} {S}_{i , j} ,$$

$$j = {ℰ}_{i}^{part}$$

wherein S_{i,j} is the slice score for slice j in object i obtained from the first model. Given an image volume, with initial and end slice scores s₁ and sₙ, respectively, the second model determines a list of object parts contained in the image and their coverage, as follows:

R={(part,Cₚₐᵣₜ)|∀part s.t. Cₚₐᵣₜ>τ}

wherein τ∈[0 . . . 1] is the minimum coverage required for a part to be considered as present, for example τ=0.1.

FIG. 7 shows schematically an embodiment of the present disclosure. A first model M1 is configured to receive a set of images. Each image I1, I2, I3, and I4 of the set of images represents a slice along an axis of a volume of a person's body. Note, that the images I1, I2, I3, and I4 shown in FIG. 7 correspond to the images I1, I2, I3, and I4 shown in FIG. 2. The first model M1 is configured to generate, for each image of the set of images, a slice score. The slice score represents the position of the slice within the person's body (see, e.g., FIG. 3). One or more of the slice scores is inputted into a second model M2. The second model M2 is configured to determine, on the basis of one or more slice scores, a body part information R. The body part information R indicates which part/parts of the person's body are depicted in the set of medical images. The body part information R can be outputted, e.g., displayed on a monitor and/or printed out on a printer and/or stored on a data storage medium.

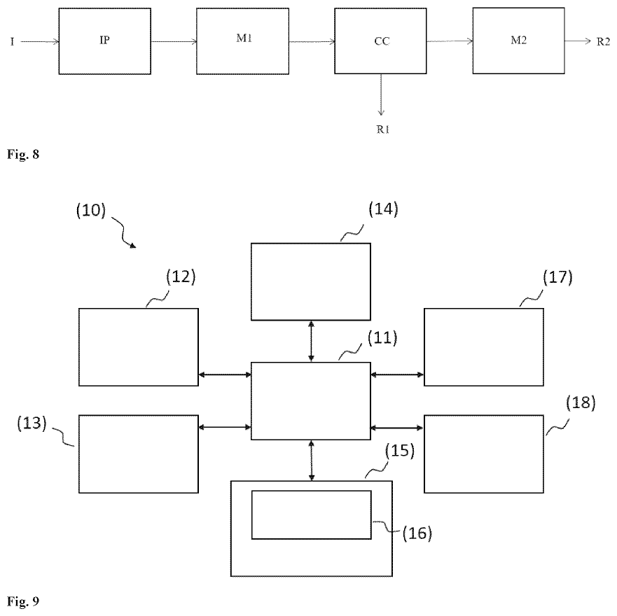

FIG. 8 shows schematically a preferred embodiment of the present disclosure. An image I is inputted into an image processing unit IP. The image I is a 3D image of a volume of an object. In other words: the 3D image shows a volume within the body of the object. The aim is to determine which part(s) of the object the 3D image is/are showing, or, in other words, which part(s) of the object are covered by the volume depicted in the 3D image. The preprocessing unit is configured to generate, from the 3D image, a set of 2D images, each 2D image depicting a slide along a defined axis of the volume of the object. The set of 2D images is inputted into a first model M1. The first model is configured to generate, for each 2D image inputted into the first model, a slice score, the slice score representing the position of the slice within the object along the defined axis. The slice scores generated by the first model are inputted into a consistency check unit CC. The consistency check unit CC is configured to check the slice scores. Checking of the slice scores can include an outlier rejection. Outlier rejection can mean that slice scores that do not follow a linear trend are identified and removed/discarded. It is possible that a linear regression is performed in which the relation between the slice scores and the order number of the slices is approximated by a linear function. Outlier rejection can also be done by employing other methods. In case a linear regression is performed, the coefficient of determination r² can be calculated which provides a measure of how well the slice scores can be approximated by a linear function of the order number. In the event of a deviation of the coefficient of determination r² above a pre-defined threshold value (e.g., 0.5), a message R1 can be outputted, the message informing a user that for the set of images no object part(s) information can be determined. The message R1 can be outputted, e.g., displayed on a monitor and/or printed out on a printer and/or stored on a data storage medium. If the consistency check did not reveal any inconsistencies, the (non-removed) slice scores are inputted into a second model M2. The second model M2 is configured to determine, on the basis of one or more slice scores, an object part information R2. The object part information R2 indicates which part/parts of the object are depicted in the set of images. The object part information R2 can be outputted, e.g., displayed on a monitor and/or printed out on a printer and/or stored on a data storage medium.

In a preferred embodiment, the object part information is combined with the image or the set of images inputted into the first model. Combining can mean that the information about which part(s) the image(s) show(s) is written into the header of the image(s) as a meta-information and/or that the information about which part(s) the image(s) show(s) is stored together with the respective image(s) in a data storage. By doing so, the information about the content of the image(s) is easily available and can be used to decide whether the image(s) can be used for a certain purpose, e.g., for training a machine learning model to perform a certain task.

Preferred embodiments of the present disclosure are:
1. A method comprising the following steps:
   providing a first model, wherein the first model is or comprises a machine learning model which was trained on training data to determine slice scores on the basis of images, wherein the training data comprise, for each object of a multitude of objects, i) a set of reference images, each reference image representing a slice along an axis of a volume of the object, each slice being oriented perpendicular to the axis, and ii) a slice order, the slice order indicating the order in which the slices follow one each other along the axis of the volume of the object, wherein the slice scores are representative of the position of the slices within the object along the axis
   receiving at least one image, the image representing a slice, the slice being oriented perpendicular to an axis of a volume of an object
   inputting the at least one image into a first model
   receiving, from the first model, for each image inputted into the first model, a slice score
   providing a second model, wherein the second model is configured to determine, on the basis of a slice score, an object part information, wherein the object part information indicates to which part/parts of the object the slice belongs to
   inputting the slice score into the second model
   receiving from the second model an object part information
   outputting and or storing the object part information and/or information related thereto.
2. A computer-implemented method comprising the following steps:
   receiving a set of images, wherein the set of images comprises a plurality of images, each image representing a slice, each slice being oriented perpendicular to an axis of a volume of an object, the object being divided into different parts,
   inputting each image into a first model, wherein the first model is or comprises a machine learning model which was trained on training data to determine slice scores on the basis of images, wherein the training data comprise, for each object of a multitude of objects, i) a set of reference images, each reference image representing a slice along an axis of a volume of the object, each slice being oriented perpendicular to the axis, and ii) a slice order, the slice order indicating the order in which the slices follow one each other along the axis of the volume of the object, wherein the slice scores are representative of the position of the slices within the object along the axis,
   receiving, from the first model, for each image inputted into the first model, a slice score,
   inputting one or more slice scores into a second model, wherein the second model is configured to determine, on the basis of a slice score, an object part information, wherein the object part information indicates to which part/parts of the object the slice belongs to,
   receiving from the second model, for each slice score inputted into the second model, an object part information,
   combining the object part information with the respective image and storing the respective image together with the object part information in a data storage.
3. A computer-implemented method comprising the following steps:
   receiving a 3D representation of a volume of an object
   generating a set of 2D images from the 3D representation, each 2D image representing a slice, each slice being oriented perpendicular to a defined axis of the volume of the object,
   inputting each 2D image into a first model, wherein the first model is or comprises a machine learning model which was trained on training data to determine slice scores on the basis of images, wherein the training data comprise, for each object of a multitude of objects, i) a set of reference images, each reference image representing a slice along an axis of a volume of the object, each slice being oriented perpendicular to the axis, and ii) a slice order, the slice order indicating the order in which the slices follow one each other along the axis of the volume of the object, wherein the slice scores are representative of the position of the slices within the object along the axis,
   receiving, from the first model, for each 2D image inputted into the first model, a slice score,
   inputting one or more slice scores into a second model, wherein the second model is configured to determine, on the basis of a slice score, an object part information, wherein the object part information indicates to which part/parts of the object the slice belongs to,
   receiving from the second model, for each slice score inputted into the second model, an object part information, the object part information indicating to which part/parts of the object the slice belongs to,
   combining the object part information with the respective 2D image and storing the respective 2D image together with the object part information in a data storage.
4. A computer-implemented method comprising the following steps:
   receiving a first set of 2D images, the first set of 2D images representing a stack of slices of a volume of an object, wherein the slices are not oriented perpendicular to a defined axis of the volume of the object
   generating a 3D representation of the volume from the first set of 2D images
   generating a set of 2D images from the 3D representation, each 2D image of the set of 2D images representing a slice, each slice being oriented perpendicular to the defined axis of the volume of the object 1 inputting each 2D image into a first model, wherein the first model is or comprises a machine learning model which was trained on training data to determine slice scores on the basis of images, wherein the training data comprise, for each object of a multitude of objects, i) a set of reference images, each reference image representing a slice along an axis of a volume of the object, each slice being oriented perpendicular to the axis, and ii) a slice order, the slice order indicating the order in which the slices follow one each other along the axis of the volume of the object, wherein the slice scores are representative of the position of the slices within the object along the axis
   receiving, from the first model, for each 2D image inputted into the first model, a slice score
   inputting one or more slice scores into a second model, wherein the second model is configured to determine, on the basis of a slice score, an object part information, wherein the object part information indicates to which part/parts of the object the slice belongs to
   receiving from the second model, for each slice score inputted into the second model, an object part information, the object part information indicating to which part/parts of the object the slice belongs to
   combining the object part information with the respective 2D image and storing the respective 2D image together with the object part information in a data storage.
5. A computer-implemented method comprising the following steps:
   receiving a first set of 2D images, the first set of 2D images representing a stack of slices of a volume of an object, wherein the slices are not oriented perpendicular to a defined axis of the volume of the object
   generating a 3D representation of the volume from the first set of 2D images
   generating a set of 2D images from the 3D representation, each 2D image of the set of 2D images representing a slice, each slice being oriented perpendicular to the defined axis of the volume of the object
   inputting each 2D image into a first model, wherein the first model is or comprises a machine learning model which was trained on training data to determine slice scores on the basis of images, wherein the training data comprise, for each object of a multitude of objects, i) a set of reference images, each reference image representing a slice along an axis of a volume of the object, each slice being oriented perpendicular to the axis, and ii) a slice order, the slice order indicating the order in which the slices follow one each other along the axis of the volume of the object, wherein the slice scores are representative of the position of the slices within the object along the axis
   receiving, from the first model, for each 2D image inputted into the first model, a slice score
   inputting one or more slice scores into a second model, wherein the second model is configured to determine, on the basis of a slice score, an object part information, wherein the object part information indicates to which part/parts of the object the slice belongs to
   receiving from the second model, for each slice score inputted into the second model, an object part information, the object part information indicating to which part/parts of the object the slice belongs to
   combining the object part information with the respective 2D image and storing the respective 2D image together with the object part information in a data storage.
6. A computer-implemented method comprising the following steps:
   receiving a set of images, wherein the set of images comprises a plurality of images, each image representing a slice, each slice being oriented perpendicular to an axis of a volume of an object, the object being divided into different parts
   inputting each image into a first model, wherein the first model is or comprises a machine learning model which was trained on training data to determine slice scores on the basis of images, wherein the training data comprise, for each object of a multitude of objects, i) a set of reference images, each reference image representing a slice along an axis of a volume of the object, each slice being oriented perpendicular to the axis, and ii) a slice order, the slice order indicating the order in which the slices follow one each other along the axis of the volume of the object, wherein the slice scores are representative of the position of the slices within the object along the axis
   receiving, from the first model, for each image inputted into the first model, a slice score
   inputting two limiting slice scores into a second model, the limiting slice scores limiting the volume along the axis, wherein the second model is configured to determine, on the basis of a slice score, an object part information, wherein the object part information indicates to which part/parts of the object the slice belongs to
   receiving from the second model, an object part information, the object part information indicating to which part/parts of the object the volume is covering
   combining the object part information with the set of images and storing the respective set of images together with the object part information in a data storage.
7. The method according to any one of the embodiments 1 to 6, wherein the first model was trained in a training process, the training process comprising the following steps:
   receiving a training data set, the training data set comprising, for each object of a multitude of objects,
   i) a set of reference images, each reference image representing a slice along an axis of a volume of the object, each slice being oriented perpendicular to the axis of the volume of the object
   ii) a slice order, the slice order indicating the order in which the slices follow each other along the axis of the volume of the object
   inputting the reference images into the first model
   receiving from the first model a slice score for each reference medical image inputted into the first model, the slice score representing the position of the slice along the axis
   computing a loss value on the basis of the slice scores and the slice order using a loss function L, the loss function L comprising at least an order loss term L_{order}, a distance loss term L_{dist}, and a slice-gap loss term L_{slice-gap}
   wherein the order loss term L_{order} penalizes first model parameters which result in a sequence of slice scores according to their magnitude which does not correspond to the score order
   wherein the distance loss term L_{dist} penalizes first model parameters which result in slice scores for which the differences of two pairs of equidistant slices are not equal
   wherein the slice-gap loss term L_{slice-gap} penalizes first model parameters which result in slice scores for which the difference between two slice scores is not proportional to the physical distance between the two slices
   modifying first model parameters in a way that reduces the loss value to a defined minimum.
8. The method according to any one of the embodiments 1 to 7, wherein the first model was trained in a training process, the training process comprising the following steps:
   generating, for a plurality of reference images, a plurality of low sampling images
   using the low sampling images as additional training data
   computing a loss value on the basis of the slice scores and the slice order using a loss function L, the loss function L comprising at least a down-sampling loss term L_{down-sampling}, wherein the down-sampling loss term L_{down-sampling} rewards first model parameters which result in equal slice scores for low-sampling images and reference images the low-sampling images were generated from
   modifying first model parameters in a way that reduces the loss value to a defined minimum
9. The method according to embodiment 8, wherein the training process is based on the loss function L defined as

L=α·L_{order}+β·L_{dist}+γ·L_{slice-gap}+δ·L_{down-sampling}

wherein which α, β, γ and δ are weighting factors, wherein α, β, γ and δ are greater than zero.
10. The method according to any one of the embodiments 1 to 9, wherein the object is a human being or an animal or a plant or a part thereof, preferably a human being.
11. The method according to any one of the embodiments 1 to 10, wherein each image is a medical image.
12. The method according to any one of the embodiments 1 to 11, wherein the method further comprises the steps:
   identifying slice scores which are outliers and removing them, and/or
   checking whether there is a linear relation between the slice scores and the slice order,
   inputting slice scores into the second model only in the event that there is a linear relation between the slice scores and the slice order.

The operations in accordance with the teachings herein may be performed by at least one computer system specially constructed for the desired purposes or at least one general-purpose computer system specially configured for the desired purpose by at least one computer program stored in a typically non-transitory computer readable storage medium.

The term “non-transitory” is used herein to exclude transitory, propagating signals or waves, but to otherwise include any volatile or non-volatile computer memory technology suitable to the application.

A “computer system” is a system for electronic data processing that processes data by means of programmable calculation rules. Such a system usually comprises a “computer”, that unit which comprises a processor for carrying out logical operations, and also peripherals.

In computer technology, “peripherals” refer to all devices which are connected to the computer and serve for the control of the computer and/or as input and output devices. Examples thereof are monitor (screen), printer, scanner, mouse, keyboard, drives, camera, microphone, loudspeaker, etc. Internal ports and expansion cards are, too, considered to be peripherals in computer technology.

Computer systems of today are frequently divided into desktop PCs, portable PCs, laptops, notebooks, netbooks and tablet PCs and so-called handhelds (e.g., smartphone); all these systems can be utilized for carrying out the disclosure.

The term “process” as used above is intended to include any type of computation or manipulation or transformation of data represented as physical, e.g., electronic, phenomena which may occur or reside, e.g., within registers and/or memories of at least one computer or processor. The term processor includes a single processing unit or a plurality of distributed or remote such units.

Any suitable input device, such as but not limited to a camera sensor, may be used to generate or otherwise provide information received by the system and methods shown and described herein. Any suitable output device or display may be used to display or output information generated by the system and methods shown and described herein. Any suitable processor/s may be employed to compute or generate information as described herein and/or to perform functionalities described herein and/or to implement any engine, interface or other system described herein. Any suitable computerized data storage, e.g., computer memory may be used to store information received by or generated by the systems shown and described herein. Functionalities shown and described herein may be divided between a server computer and a plurality of client computers. These or any other computerized components shown and described herein may communicate between themselves via a suitable computer network.

FIG. 9 illustrates a computer system (10) according to some example implementations of the present disclosure in more detail. Generally, a computer system of exemplary implementations of the present disclosure may be referred to as a computer and may comprise, include, or be embodied in one or more fixed or portable electronic devices. The computer may include one or more of each of a number of components such as, for example, processing unit (11) connected to a memory (15) (e.g., storage device).

The processing unit (11) may be composed of one or more processors alone or in combination with one or more memories. The processing unit is generally any piece of computer hardware that is capable of processing information such as, for example, data (incl. digital images), computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit (11) may be configured to execute computer programs, which may be stored onboard the processing unit or otherwise stored in the memory (15) of the same or another computer.

The processing unit (11) may be a number of processors, a multi-core processor or some other type of processor, depending on the particular implementation. Further, the processing unit may be implemented using a number of heterogeneous processor systems in which a main processor is present with one or more secondary processors on a single chip. As another illustrative example, the processing unit may be a symmetric multi-processor system containing multiple processors of the same type. In yet another example, the processing unit may be embodied as or otherwise include one or more ASICs, FPGAs or the like. Thus, although the processing unit may be capable of executing a computer program to perform one or more functions, the processing unit of various examples may be capable of performing one or more functions without the aid of a computer program. In either instance, the processing unit may be appropriately programmed to perform functions or operations according to example implementations of the present disclosure.

The memory (15) is generally any piece of computer hardware that is capable of storing information such as, for example, data, computer programs (e.g., computer-readable program code (16)) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD, Blu-ray disk or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory (15), the processing unit (11) may also be connected to one or more interfaces (12, 13, 14, 17, 18) for displaying, transmitting and/or receiving information. The interfaces may include one or more communications interfaces (17, 18) and/or one or more user interfaces (12, 13, 14). The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) to connect to a network, such as using technologies such as cellular telephone, Wi-Fi, satellite, cable, digital subscriber line (DSL), fiber optics and the like. In some examples, the communications interface(s) may include one or more short-range communications interfaces configured to connect devices using short-range communications technologies such as NFC, RFID, Bluetooth, Bluetooth LE, ZigBee, infrared (e.g., IrDA) or the like.

The user interfaces (12, 13, 14) may include a display (14). The display (14) may be configured to present or otherwise display information to a user, suitable examples of which include a liquid crystal display (LCD), light-emitting diode display (LED), plasma display panel (PDP) or the like. The user input interface(s) (12, 13) may be wired or wireless, and may be configured to receive information from a user into the computer system (10), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

1. A computer-implemented method comprising:
receiving at least one image, the image representing a slice, the slice being oriented perpendicular to an axis of a volume of an object;
inputting the at least one image into a first model;
receiving, from the first model, for each image inputted into the first model, a slice score, the slice score being representative of the position of the slice within the object along the axis, inputting the slice score into a second model;
receiving from the second model an object part information, the object part information indicating to which part/parts of the object the slice belongs to; and
outputting and or storing the object part information and/or information related thereto.

2. The method of claim 1, wherein the first model is or comprises a machine learning model which was trained on training data to determine slice scores on the basis of images, wherein the training data comprise, for each object of a multitude of objects;
a set of reference images, each reference image representing a slice along an axis of a volume of the object, each slice being oriented perpendicular to the axis, and
a slice order, the slice order indicating the order in which the slices follow one each other along the axis of the volume of the object.

3. The method of claim 1, wherein the second model is configured to determine, based on the slice score, an object part information, wherein the object part information indicates to which part/parts of the object the slice belongs to.

4. The method of claim 1, further comprising:
receiving a set of images, wherein the set of images comprises a plurality of images, each image representing a slice, each slice being oriented perpendicular to an axis of a volume of an object, the object being divided into different parts;
inputting each image into the first model,
receiving, from the first model, for each image inputted into the first model, a slice score, the slice score being representative of the position of the slice within the object along the axis,
inputting one or more slice scores into the second model,
receiving from the second model, for each slice score inputted into the second model, an object part information, the object part information indicating to which part/parts of the object the slice belongs to, and
combining the object part information with the respective image and storing the respective image together with the object part information in a data storage.

5. The method of claim 1 further comprising:
receiving a 3D representation of the volume of the object;
generating a set of 2D images from the 3D representation, each 2D image representing a slice, each slice being oriented perpendicular to a defined axis of the volume of the object;
inputting each 2D image into the first model;
receiving, from the first model, for each 2D image inputted into the first model, a slice score, the slice score being representative of the position of the slice within the object along the axis;
inputting one or more slice scores into the second model;
receiving, from the second model, for each slice score inputted into the second model, an object part information, the object part information indicating to which part/parts of the object the slice belongs to; and
combining the object part information with the respective 2D image and storing the respective 2D image together with the object part information in a data storage.

6. The method of claim 1, further comprising:
receiving a first set of 2D images, the first set of 2D images representing a stack of slices of a volume of an object, wherein the slices are not oriented perpendicular to a defined axis of the volume of the object;
generating a 3D representation of the volume from the first set of 2D images;
generating a set of 2D images from the 3D representation, each 2D image of the set of 2D images representing a slice, each slice being oriented perpendicular to the defined axis of the volume of the object;
inputting each 2D image into the first model;
receiving, from the first model, for each 2D image inputted into the first model, a slice score, the slice score being representative of the position of the slice within the object along the axis;
inputting one or more slice scores into the second model;
receiving, from the second model, for each slice score inputted into the second model, an object part information, the object part information indicating to which part/parts of the object the slice belongs to; and
combining the object part information with the respective 2D image and storing the respective 2D image together with the object part information in a data storage.

7. The method of claim 1, comprising the steps:
receiving a plurality of images, each image representing a slice, each slice being oriented perpendicular to an axis of a volume of an object, the object being divided into different parts;
inputting each image into the first model;
receiving, from the first model, for each image inputted into the first model, a slice score, the slice score being representative of the position of the slice within the object along the axis;
inputting two limiting slice scores into the second model, the limiting slice scores limiting the volume along the axis;
receiving, from the second model, an object part information, the object part information indicating to which part/parts of the object the volume is covering; and
combining the object part information with the set of images and storing the respective set of images together with the object part information in a data storage.

8. The method of claim 1, wherein the first model was trained in a training process comprising:
receiving a training data set, the training data set comprising, for each object of a multitude of objects:
a set of reference images, each reference image representing a slice along an axis of a volume of the object, each slice being oriented perpendicular to the axis of the volume of the object, and
a slice order, the slice order indicating the order in which the slices follow each other along the axis of the volume of the object;
inputting the reference images into the first model;
receiving, from the first model, a slice score for each reference medical image inputted into the first model, the slice score representing the position of the slice along the axis;
computing a loss value on the basis of the slice scores and the slice order using a loss function L, the loss function L comprising at least an order loss term L_{order}, a distance loss term L_{dist}, and a slice-gap loss term L_{slice-gap}, wherein:
the order loss term L_{order} penalizes first model parameters which result in a sequence of slice scores according to their magnitude which does not correspond to the score order,
the distance loss term L_{dist} penalizes first model parameters which result in slice scores for which the differences of two pairs of equidistant slices are not equal, and
the slice-gap loss term L_{slice-gap} penalizes first model parameters which result in slice scores for which the difference between two slice scores is not proportional to the physical distance between the two slices; and
modifying first model parameters in a way that reduces the loss value to a defined minimum.

9. The method of claim 2, the first model was trained in a training process comprising:
generating, for a plurality of reference images, a plurality of low sampling images;
using the low sampling images as additional training data;
computing a loss value on the basis of the slice scores and the slice order using a loss function L, the loss function L comprising at least a down-sampling loss term L_{down-sampling}, the down-sampling loss term L_{down-sampling} rewards first model parameters which result in equal slice scores for low-sampling images and reference images the low-sampling images were generated from; and
modifying first model parameters in a way that reduces the loss value to a defined minimum

10. The method of claim 9, the training process is based on the loss function L defined as
L=α·L_{order}+β·L_{dist}+γ·L_{slice-gap}+δ·L_{down-sampling}
wherein which α, β, γ and δ are weighting factors, wherein α, β, γ and δ are greater than zero.

11. The method of claim 1, wherein the object is a human being or an animal or a plant or a part thereof, preferably a human being.

12. The method of claim 11, wherein each image is a medical image.

13. The method of claim 1, further comprising:
identifying slice scores which are outliers and removing them, and/or
checking whether there is a linear relation between the slice scores and the slice order, and
inputting slice scores into the second model only in the event that there is a linear relation between the slice scores and the slice order.

14. A computer system comprising:
a processor; and
a memory storing an application program configured to perform, when executed by the processor, an operation, the operation comprising:
receiving at least one image, the image representing a slice, the slice being oriented perpendicular to an axis of a volume of an object;
inputting the at least one image into a first model;
receiving, from the first model, for each image inputted into the first model, a slice score, the slice score being representative of the position of the slice within the object along the axis;
inputting the slice score into a second model;
receiving from the second model an object part information, the object part information indicating to which part/parts of the object the slice belongs to; and
outputting and or storing the object part information and/or information related thereto.

15. A non-transitory computer readable medium having stored thereon software instructions that, when executed by a processor of a computer system, cause the computer system to execute the following steps:
receiving at least one image, the image representing a slice, the slice being oriented perpendicular to an axis of a volume of an object;
inputting the at least one image into a first model;
receiving, from the first model, for each image inputted into the first model, a slice score, the slice score being representative of the position of the slice within the object along the axis;
inputting the slice score into a second model;
receiving from the second model an object part information, the object part information indicating to which part/parts of the object the slice belongs to; and
outputting and or storing the object part information and/or information related thereto.
